(19) United States
(12) Patent Application Publication
(10) Pub. No.: US 2002/0010671 A1
(43) Pub. Date: Jan. 24, 2002

(54) Method and system for executable web-object trading

(76) Inventor: Fu-Chien Tsai, Mai Liao Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/747,996

(22) Filed: Dec. 27, 2000

(30) Foreign Application Priority Data
Jul. 7, 2000 (TW) 089113631

(51) Int. Cl. G06F 17/60; G06F 15/16

(52) U.S. Cl. 705/37; 705/26; 709/203

(57) ABSTRACT

A system and method for executable web-object trading for web-site creators is to provide additional features and services for their web-sites. The web-site creators may purchase web-objects, obtain expertise services from network experts, construct a self-defined web-object, or acquire data mining services by using the system. As a result, the web-site creator who only has limited web-site knowledge can also easily organize a web-site with various features by embedding the web-objects into his/her web-pages. In addition, the web-site creator, web-object creator (e.g., network expert) and browsers can have more interactions by using the system of the present invention to provide better services in the network.

### 1. FIELD OF The INVENTION

This invention relates to a method and system for executable web-object trading, and particularly to method and system which can allow an internet browser to purchase and embed a pre-defined web-object into his/her homepage for providing additional features. In addition, the web-object creator can also promote new web-object or discuss and bargain with his browser about the features and price of the web-object by using the method and system of this invention.

### 2. BACKGROUND OF THE INVENTION

Nowadays, computer networks and electronic commerce are developing rapidly. People can communicate, exchange information and make business with each other very easily and rapidly. Although there is a lot of precious information provided in the Internet However, it is difficult for the network browser to find an information which he/she really needs in an efficient way. Contrary, web-site creator also suffers the difficulty of creating a web-site or homepage with high browsing frequency.

The present invention provides a concept of web-object marketing to decrease the cost for constructing a web-site. The web-site creator does not need much knowledge to organize a web-site. He can simply hyperlink his web-page to the system of the present invention and then obtain a serial of expertise services from the system. He can purchase and embed the executable web-objects into his own web-page to provide additional features. Therefore a web-page (web-site) with various features can easily be constructed with low cost of capitals.

Many so called “search engines” or “portal sites” are created for browsers to search for what they want in a more convenient manner. Conventional search engines (portal sites) use “hyperlink” feature for leading or directing browsers to the web-site which they are searching for. If browsers found the web-site which were directed was not what they are interested, they have to leave that web-site and come back to the search engine again. Then, they will have to hyperlink to yet another web-site to check if there is something interesting. Such kind of searching procedure is not only tedious and tiresome, but also is a waste of both time and money in Internet connection.

In addition, conventional search engines (portal sites) only provide limited text-based introductions and hyperlinks (e.g., URL addresses of web-sites) for directing browsers to the web-sites which they are searching for. Only very simple features are provided by conventional search engines. In this way, the web-site creators or home page makers will have to take all the responsibility of providing all the useful features and contents of their web-site or home page. The web-site creators and home page makers can neither share experiences nor take advantages of the expertise of search engines. That means there are no relationship and interaction between conventional search engines, web-site creators, and browsers.

### SUMMARY OF THE INVENTION

In view of aforesaid disadvantages, it is therefore an object of this invention to provide a system and a method to provide advanced features for the search engines (portal sites). Such kind of advanced features can allow the web-site creators to purchase a web-object with predefined feature from the system and then embed into his/her own web-site (or home page). Therefore, web-site creators can create a web-site (home page) with various features bought from the system easily and rapidly. Very few expertise and experience are needed for the web-site creators to create a web-site because the system of the present invention has provided almost all what they need already. The system of the present invention also provides data mining service to compile statistical data for web-site creators. In addition, this system provides a platform for the search engines, web-site creators and browsers to interact thereon such that better service and higher efficiency of the internet can be achieved.

It is another object of this invention to provide a system and a method to create a platform for network experts (for example, web-object creators) to sell their web-objects. Web-site creators can discuss with network experts about their needed network features by using the system. Experts can then design web-objects for providing the discussed network features for web-site creators to purchase. Moreover, those new designed web-objects can then be left in the system for other customers to choose and buy. Profit obtained from selling these new designed web-objects is shared by the web-site creators (who set up the specifications of the web-objects), experts (who design the web-objects), and the owner of the system (who provides the platform for trading).

It is a further object of the present invention to provide a system and a method to improve the efficiency of the search engine. Browsers can seek for information in a more efficient and accurate way with less “click” operations.

In order to achieve the above mentioned objects, a preferred embodiment of the system of the present invention includes the following modules and databases:

a mainframe for organizing the system, the mainframe being communicating with a network and capable for allowing at least a user to login the mainframe via the network for accessing the system;

a web-object database for storing a plurality of executable web-objects therein, each web-object being capable to proceed a serial of pre-defined processes for performing a pre-determined feature;

a membership database for recording at least a registered data of the user;

a linking module for comparing a login record of the user with the registered data saved in the membership database to check if the user is authorized to select web-objects from the web-object database;

a network service module for proceeding a procedure for the user to purchase web-objects, a procedure for the web-object creator to register his/her web-object to the system and stored in the web-object database for others to purchase and a procedure for the web-site creator to register his/her web-site to the system for others to browse;

a web-object constructing module for the web-site creator to set up and modify initial settings and parameters of the web-object for future operations, the web-site creator being able to use the web-object constructing module to publish required features and functions of a self-defined web-object on the system such that the web-object creator will be able to produce the self-defined web-object based on the required features and functions;

a profit sharing module for recording a profit sharing ratio of the self-defined web-object, profit obtained by further trading of the self-defined web-object will be shared by the web-site creator and the web-object creator based on said profit sharing ratio; and

a web-object embedding module for embedding the web-object selected by the user onto a web-page for providing said feature.

A preferred embodiment of the method for using the system of the present invention includes the following steps:

(a) the user logging in the system via the network and generating the login record;

(b) the linking module comparing the login record with the membership data stored in the membership database of the system;

(c) the user selecting a web-object from the web-object database;

(d) proceeding a trading procedure when at least one web-object is selected by the user;

(e) embedding the selected web-object into the web-page by the web-object embedding module of the system after completing said trading procedure.

In a preferred embodiment, the step (e) further includes the following steps:

(e1) the user deciding to save the web-object in either his/her web-site or the system;

(e2) the system transferring the web-object and the initial parameters to the web-site if the user decides to keep the web-object in that web-site;

(e3) the system requesting the user to transfer the web-page to the system and stored therein, then embedding the web-object into the web-page.

Preferably, a web-object constructing procedure will be performed if the user cannot find any suitable web-object from the web-object database in step (c), wherein the web-object constructing procedure includes the following steps:

(c1) requesting the user to fill in a requirement table for stating required features and specifications of the web-object and due date for completing the web-object;

(c2) publishing the required specifications and features of the web-object on a Bulletin Board of the system to allow a web-object creator to access these information via the network;

(c21) checking the due date, if the due date has expired then delete the published specifications and features from the Bulletin Board;

(c3) performing a meeting by the user and the web-object creator for discussing future selling price, profit sharing ratio and detailed features of the web-object; and

(c4) the web-object creator completing the web-object and transferring the web-object to the user via the system.

### BRIEF DESCRIPTION OF THE DRAWINGS

The invention, as well as its many advantages, may be further understood by the following detailed description and drawings in which:

FIG. 1 is a systematic diagram of the present invention which illustrates the facilities and media used by the web-site creators, network browsers and experts to access the system of the present invention.

FIG. 2 is a block diagram illustrating the interactive relations among the web-site creators, network browsers, network experts, and the system of the present invention.

FIG. 3A is a flowchart which demonstrates the processes for the web-site creator to use the system of this invention to purchase web-objects.

FIG. 3B is a flowchart which depicts the processes for the web-site creator to discuss with the network expert about the design of a web-object by using the system of the present invention.

FIG. 4 is a flowchart which depicts the processes for the network expert to register his web-object in the system of the present invention for others to purchase.

FIG. 5 is a flowchart illustrating the processes for the browsers to search information from the network.

FIG. 6 is a diagram illustrating a preferred homepage showing a search result displayed for the browsers.

### DETAILED DESCRIPTION OF THE PREFERRED EMBODIMENT

The system of the present invention includes hardware facilities and system configurations. The hardware facilities include any facility or equipment which can be used for accessing the network (e.g., Internet). The system configurations include a plurality of software modules for conducting some specific functions on the hardware facilities The following descriptions are going to illustrate some embodiments of the present invention, including: how does a web-site creator use the system of the present invention to purchase and apply web-objects into his/her web-site for improving advanced features; how does a browser use the system to search for information in a more efficient way; how does a network expert (e.g., web-object designers) use this system to communicate and cooperate with the web-site creator to design and sell new web-objects. In addition, the following description further illustrates how does the profit obtained from selling these new designed web-objects be shared by the web-site creators (who set up the specifications of the web-objects), experts (who design the web-objects), and the owner of the system (who provide the platform for trading).

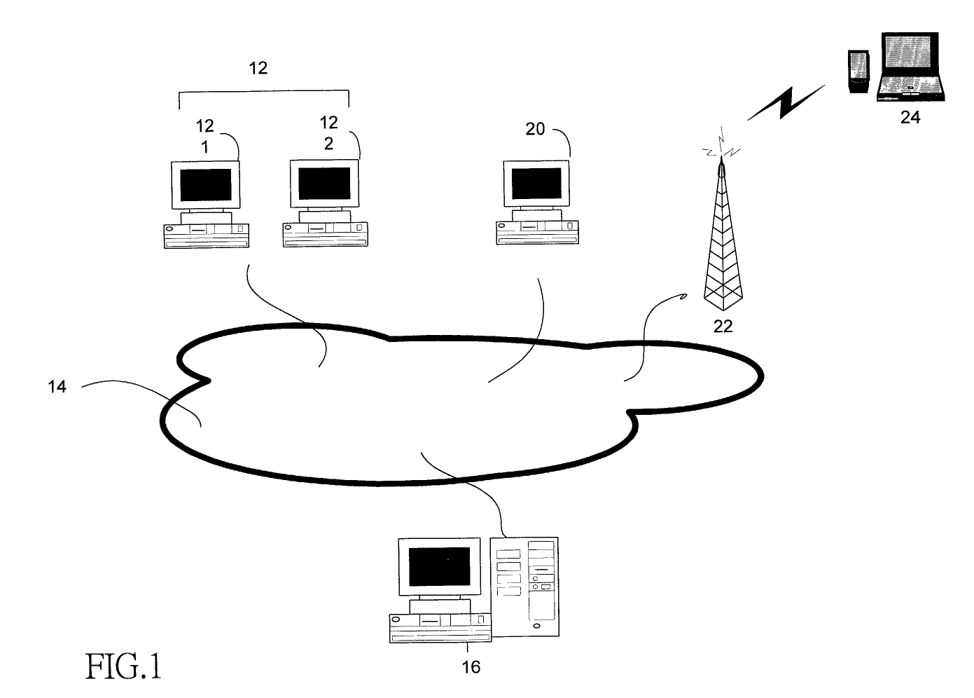

Please refer to FIG. 1 which is a systematic diagram showing the facilities and media used by the web-site creators (also referred as content provider), network browsers and network experts (also referred as web-object creator) to access the system of the present invention.

Definitions of terms used in this specification are listed hereunder:

Provider 12: Generally referring to the content provider of web-pages (i.e., homepages), web-site creator 121, or web-object creator 122 (also referred as network expert). These providers 12 can access the mainframe 16 of the system via Internet. Web-site creator 121 can embed the web-objects obtained from the system of the present invention into his/her own web-site for providing additional network features. Web-object creator 122 is the creator of the web-objects. The web-objects being created by the web-object creators 122 can be stored in the system for web-site creators 121 to purchase.

Communication Media 14: Generally referring to any means or media which can be used for computer communications. For network media, the Communication Media 14 can be referred to Internet, ISDN (integrated service digital network), PSTN (public switched telephone network), Cable Network, Radio Communication, and etc.

Mainframe 16: Providing the primary functions of the system of the present invention, which includes the operational ability and data storage of the system, and the functions to embed web-objects into web-pages. Web-site creators 121 may choose to up-load and store his/her web-pages in the mainframe 16 so as to take advantage of the web-objects embedding function for easily and rapidly increasing the provided features and add values of his/her web-pages. Web-site creators 121 may also choose to keep the web-pages within his/her own web-site. Then, he/she can purchase and download web-objects to his/her web-site via the Communication Media 14 for embedding. Moreover, the trading platform of the web-objects is also provided by the mainframe 16. Browsers 20 uses the Communication Media 14 for connecting with the mainframe 16 to search for needed information by inputting keywords. When a new web-object is designed, web-object creators 122 and web-site creators 121 can share the profit obtained from future trading of the web-object by the profit-sharing function provided by the mainframe 16. The mainframe 16 of the system of the present invention also performs data storage and backup functions.

Browser 20: Generally referring to any personal electronic equipment which can be used to browse the Internet, including the personal computers, cellular phones with WAP functions, palm PC, PDA (personal digital assistant), Set-top box, and etc. People can use these browsing equipments to connect with the mainframe 16 via the Communication Media 14 to search for information and web-sites, and to perform web-objects trading.

Radio station 22: Providing the means for cordless communication between the browsers 12 and the mainframe 16.

Cordless communication devices 24: Generally referring to any personal devices which can be carried by people for communication with the mainframe 16 through the radio station 24 in a cordless manner.

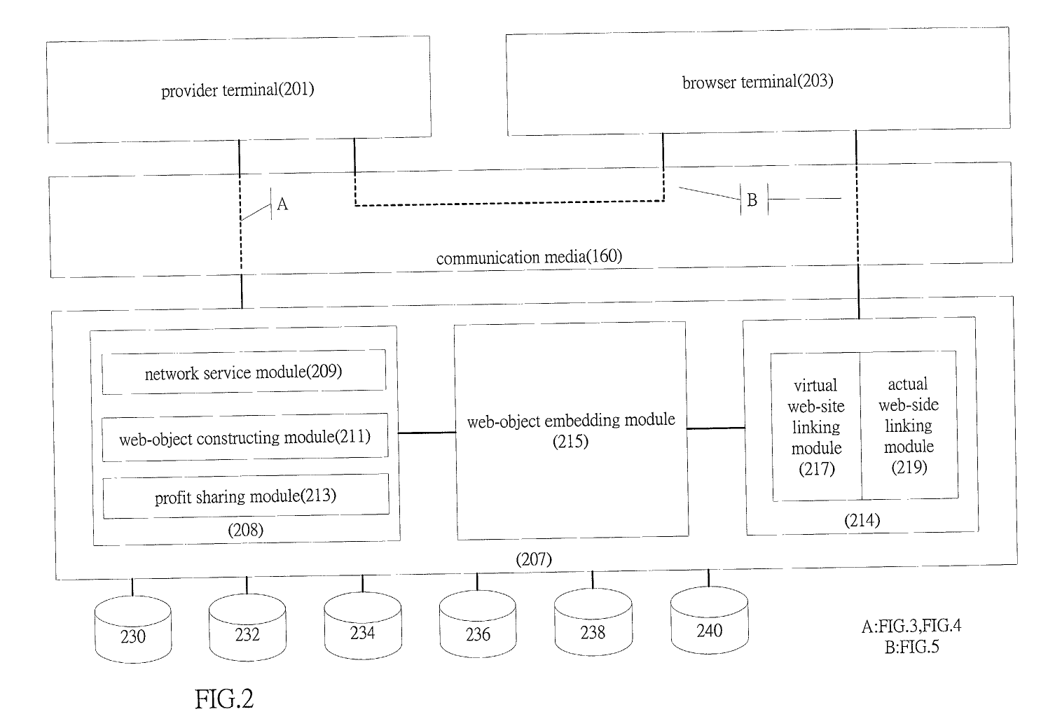

Referring to FIG. 2, which is a block diagram illustrating the interactive relations among the web-site creators, network browsers, network experts, and the system of the present invention. The block diagram shown in FIG. 2 can be divided into three major parts: the provider terminal 201, the browser terminal 203, and the software system 207. These three parts 201, 203 and 207 are connected for communication through the Communication Media 160.

The provider terminal 201 is a terminal used by the web-site creators 121 and web-object creators 122 for connecting and communicating with the mainframe 16. It includes Email (Electronic Mail) communication, file transmission through Internet, Internet connection by using cellular phone, or Internet connection by using set-top box.

The browser terminal 203 is a terminal used by the browsers 20 for connecting and communicating with the mainframe 16. It includes Internet connection by using PC, Email communication, file transmission through Internet, Internet connection by using cellular phone, or Internet connection by using set-top box.

The software system 207 comprises the following modules and databases.

The modules includes: network service module 209, web-object constructing module 211, profit sharing module 213, web-object embedding module 215, and linking module 214 (which further includes the virtual web-site linking module 217 and the actual web-site linking module 219).

The databases includes: membership database 230, web-object database 232, profit sharing database 234, invoice database 236, evaluation database 238, and forum database 240.

Wherein, the network service module 209, web-object constructing module 211, and profit sharing module 213 can be referred as the trading module 208 which provides the main functions for the web-site creators and web-object creators to purchase, trade, discuss about and design web-objects.

The network service module 209 is an entrance interface for the web-site creators and web-object creators to use the system of the present invention. Once being registering as a membership of the system, the web-site creator may register his/her web-site into the system for other browsers to search and browse. The web-site creator may also shop for web-objects. Web-object creators can also register and upload his/her web-object to the system for users (including web-site creators, browsers, and other web-object creators) to purchase.

The web-object constructing module 211 provides the configure functions for the web-site creators to set up and modify the initial parameters of the web-objects for future operations. When the web-site creator cannot find any web-object from the web-object database 232 to suit his/her needs, he/she can use the web-object constructing module 211 to construct a self-defined web-object. To make a self-defined web-object, the web-site creator may firstly publish his/her required features and functions of a web-object on a forum or a bulletin board in the system. The web-object creator (network expert) can estimate the cost of time and money to design the web-object and then make contact with the web-site creator in the forum or bulletin board to discuss the details and bargain the price of the web-object. After that, the web-object creator starts to create the web-object.

The profit sharing module 213 is for sharing the profit obtained by further trading of the new designed web-object which is defined by the web-site creator and designed by the web-object creator. A profit-sharing table which contains the information about the sale price of the web-object and whom/how to share the profit will be filled in by the one (either web-site creator or web-object creator) who contributes most to the web-object. Once the profit-sharing table is filled, the system will distribute the profit based on the information recorded on the table when the new designed web-object is bought by other people in the future.

The web-object embedding module 215 will be actuated when the web-site creator completed the settings of initials and configurations of the web-object performed by the web-object constructing module 211. The web-object embedding module 215 will embed, link, or attach the web-object into the homepage (web-page) own by the web-site creator. The web-site creator can decide whether the web-object is stored in the mainframe of the system or his/her web-site having the homepage. The web-object embedding module 215 will then link (e.g., hyperlink) the web-object which is purchased by the web-site creator with his/her homepage. After that, when a browser is browsing that homepage, the embedded or linked web-object will present on a bottom side or other location of that homepage and become an additional feature thereof for increasing evaluation of that homepage. In addition, when a browser “clicks” to use that web-object, the web-object will record some specific information into the web-object database 232. Then, the web-object embedding module 21 will compile statistics of these recorded information and report to the web-site creator via internet periodically.

When a new web-object is created by the web-object creator and transmitted and stored in the mainframe of the system, the system operator will perform testing procedures to check the validity and compatibly of that web-object. If the web-object passes all of the tests, it will be saved in the web-object database 232 for other people to purchase. In addition, everybody, including the web-site creators and browsers, may use the web-object embedding module 215 to evaluate and grade the performance of the web-object. Evaluating or grading results will be kept in the evaluation database 238 as a record referring to the expertise of the web-object creator.

The virtual web-site linking module 217 provides the functions for the web-site creator to keep and store web-objects in the mainframe of the system. Therefore, when a browser clicks the web-object, not only the consequent procedures are performed by the mainframe of the system, but also the records generated by using the web-object are stored and processed by the mainframe of the system.

The actual web-site linking module 219 provides the functions for the web-site creator to store the web-objects into his/her web-site. As a result, records generated by using the web-object or input by users will not be processed by the mainframe of the system, but will be transmitted directly to the web-site and processed by the web-site creator.

Following are descriptions of the databases of the software system 207 of the present invention.

Membership database 230: everyone who wants to access or use the system of the present invention must firstly registers as a member. The registered membership records are saved in the membership database 230. Every member will be classified by a specific user level which states the limits of authority for using the system. In addition, the expertise records of web-object creators are also stored in the membership database 230.

Web-object database 232: storing the information and records of the web-objects including the titles, executable files, plug-ins, prices, conditions of usage, initial settings, and records input by users.

Profit sharing database 234: when a web-object is newly created, the web-object will be transmitted and stored into the mainframe of the system for future trading. The profit sharing tables of new defined web-objects are also saved in the profit sharing database. The profit sharing tables contain the following columns: basic data of the web-object, records of web-object creator and web-site creator, and profit sharing ratio of web-object creator and web-site creator. When the web-object is bought by other people in the future, then the system will automatically share the profit obtained by selling the web-object to the system itself, the web-object creator, and web-site creator.

Invoice database 236: storing the billing and accounting records of the system.

Evaluation database 238: When a web-object is sold, the buyer (for example, the web-site creator or browser or another web-object creator) may evaluate the web-object. When a user used one web-object, he/she can also evaluate the performance of that web-object. The evaluation records are saved in the evaluation database 238 to be a reference record for others to consider if this web-object is worthy to buy. Evaluation database 238 is related to the membership database 230 such that the evaluation records of a web-object can be further relating to the expertise of the creator of that web-object. When a web-site creator wants to find somebody to design a web-object for him/her, he/she can refer to the evaluation database 238 to see if there is someone suits his/her needs.

Forum database 240: storing and recording the discussion between web-site creator and web-object creator when they are designing a new web-object.

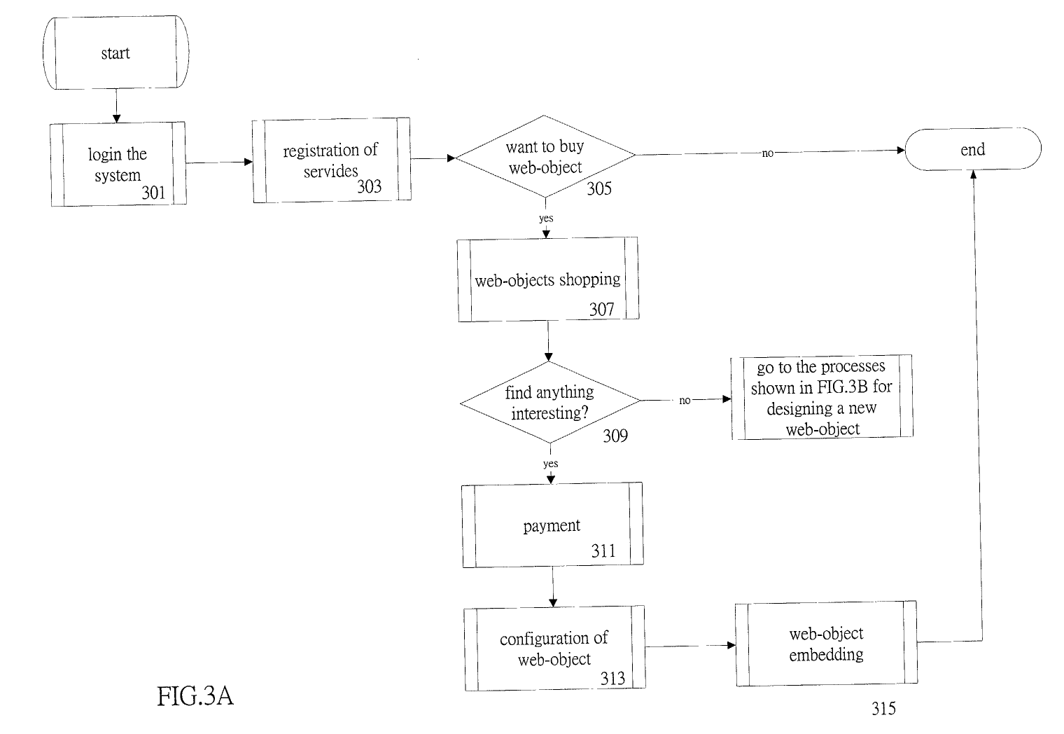

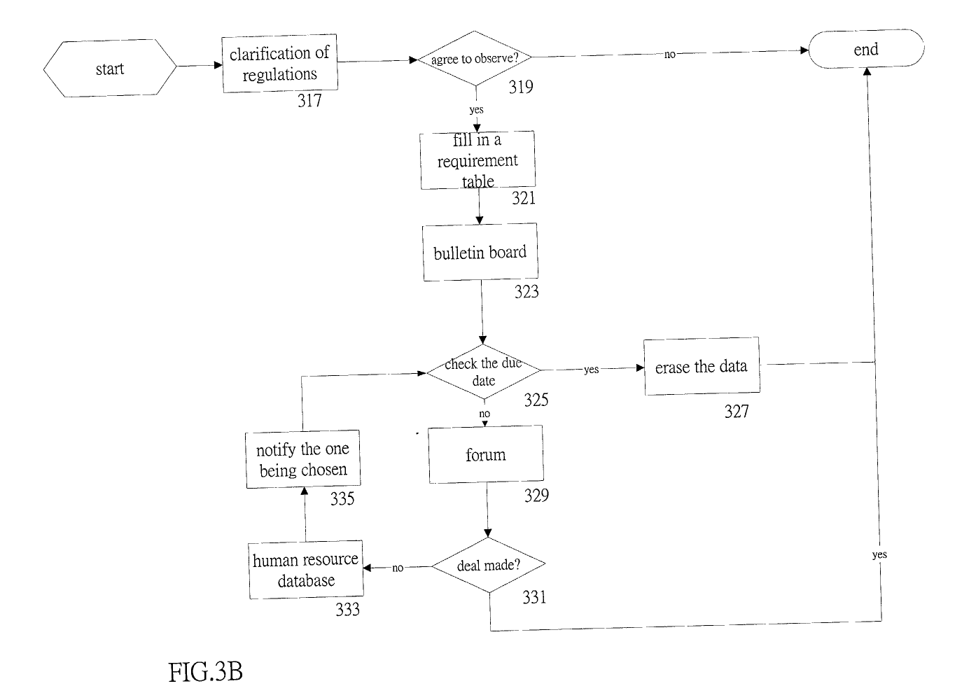

FIGS. 3A and 3B illustrate the interactive processes between the web-site creator and web-object creator. Wherein, FIG. 3A is a flowchart which demonstrates the processes for the web-site creator to use the system of this invention to purchase web-objects. FIG. 3B is a flowchart which depicts the processes for the web-site creator to discuss with the web-object creator (e.g., network expert) about the design of a web-object by using the system of the present invention.

The processes shown in FIG. 3A include the following steps:

Step 301: Login the system. A user (including browsers, web-site creators, and web-object creators) must firstly login as a membership before he/she can access the system. The user will be requested to enter his/her usemame (or membership number) when he/she tries to access the system. The system will then verify the username with the records stored in the membership database to see if that person is valid to use this system. If valid, then the system will check the limits of authority of that user from the membership database to decide what kinds of services can be provided by the system. If the username is invalid, then the user will be requested to register his/her personal data to the system again for obtaining the membership.

Step 303: Registration of services: Web-site creators (or users as referred above) can choose one of the services provided by the system. Web-site creators (or users) may register their own web-sites into the system for other browsers to search for. They can also access the web-object database to see if there is any web-object worth to buy. They can further embed web-objects into their own web-sites or web-pages to become new features or services of their web-sites.

Step 305: Want to buy web-objects? Ask the user if he/she wants to buy new web-objects? If the answer is “YES” then go to Step 307, if “NO” then go to “END”.

Step 307: Web-objects shopping: Web-site creators and users can search for needed web-objects from the list of the web-object database. Once they found a web-object which they are interested, they can either buy it or rent it.

Step 309: Find anything interesting? If the web-site creators or users found a web-object which they may want to buy, then go to Step 311, otherwise go to the processes shown in FIG. 3B for designing a new web-object.

Step 311: Payment. Buyer of the web-object is requested to pay the money in this step. The following step is proceeded only after the system confirms a full payment has been made.

Step 313: Configuration of web-object. The initial parameters and settings must be reconfigured to suit the web-page or web-site of the user (buyer).

Step 315: Web-object embedding: Hyperlink the web-object with the web-page (homepage) of the user. If the user wants to keep (store) that web-object in his/her own web-site, the all programs, data files and initial settings relating to that web-object will be transferred (downloaded) to the user side. If the user decides to leave that web-object in the web-site (mainframe) of the system, then the user will be requested to transfer (upload) his/her web-page (homepage) to the web-site of the system for hyperlink.

FIG. 3B illustrates the following steps:

Step 317: Clarification of regulations. Detailed descriptions about the regulations, personal rights and obligations are stated in this step. Users are requested to agree and sign an agreement to these regulations before they can go further.

Step 319: Agree to observe? If the user agrees to observe these regulations and has signed the agreement then go to Step 321, otherwise go to “END”.

Step 321: Fill in a requirement table. The user inputs the required specifications and features of the web-object, and states the due date for completing the design of the web-object.

Step 323:Bulletin Board. The requested specifications and features of the wanted web-object will be published on the Bulletin Board of the system. Other users (including network experts or web-object creators) can browse these information via internet.

Step 325: Check the due date. The system checks if the due date is expired. If the answer is “YES” then go to Step 327, otherwise go to Step 329.

Step 327: Erase the data. Delete the specifications and features of the web-object from the Bulletin Board.

Step 329: Forum. The user and the web-object creator meet (e.g., perform a on-line meeting) in the forum for discussing the price, profit sharing ratio and required features of the web-object in a more detailed manner.

Step 331: Deal made? If the user has made the deal with the web-object creator then go to “END”, otherwise go to Step 333.

Step 333: Human resource database. Searching for another suitable network expert from the evaluation database of the system to make the web-object.

Step 335: Notify the one being chosen. The system sends an Email to that network expert who is chosen by the user. The network expert may then make contact with the user to discuss about the price and detailed features of the web-object. They can also make a meeting in the forum.

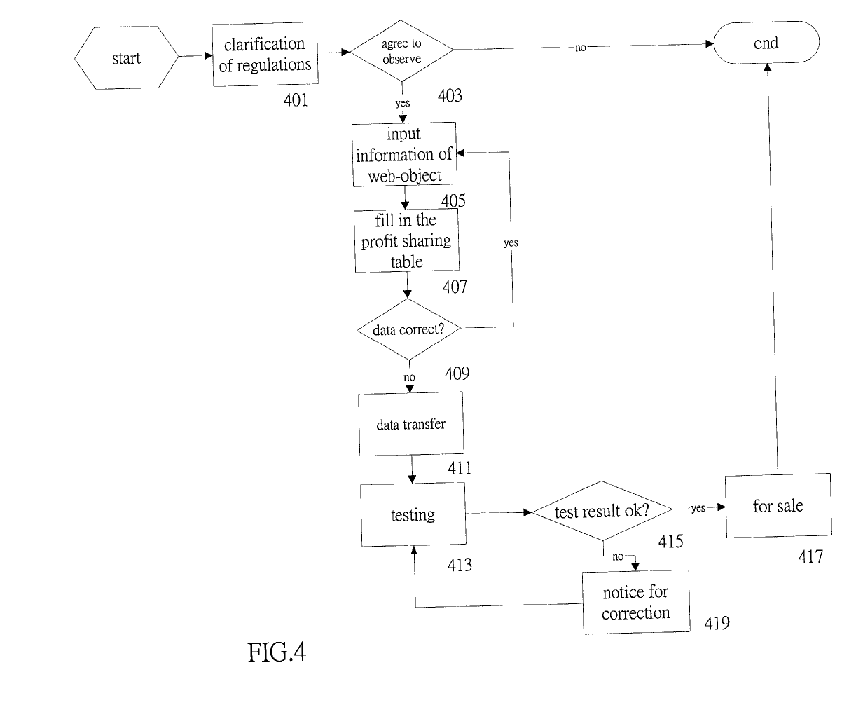

FIG. 4 is a flowchart which depicts the processes for the network expert to register his web-object in the system of the present invention for others to purchase, including the following steps:

Step 401: Clarification of regulations. Detailed descriptions about the regulations, personal rights and obligations for web-object trading are stated in this step. Users (including web-object creators which are also called as network experts) are requested to sign an agreement to these regulations.

Step 403: Agree to observe? If the web-object creator agrees to observe these regulations and has signed the agreement then go to Step 405, otherwise go to “END”.

Step 405: Input information of web-object: Input the basic information and data of the web-object which he/she wants to sell.

Step 407: Fill in the profit sharing table. The purpose of the profit sharing table is to state the profit sharing ratios of the web-object. When this web-object is sold, the profit obtained will be shared by the people with the predetermined ratio as which stated in the profit sharing table.

Step 409: Data correct? The system checks if the input information is correct? If the answer is “YES” then go to Step 411, otherwise go to Step “405” for re-input.

Step 411: Data transfer. The web-object creator transfers (uploads) the related programs, components, and data files of the web-object to the system and stored therein.

Step 413: Testing. The operators or staffs of the system test the validities, compatibilities, performances, and other experiments of the web-object.

Step 415: Test result OK? If the test result is OK then go to Step 417, otherwise go to Step 419.

Step 417: For sale. Put the data of the web-object on the list of web-objects and stored the same in the web-object database for others to purchase.

Step 419: Notice for correction. When the staffs of the system find errors or faults in the web-object, the web-object creator will be notified to correct these errors.

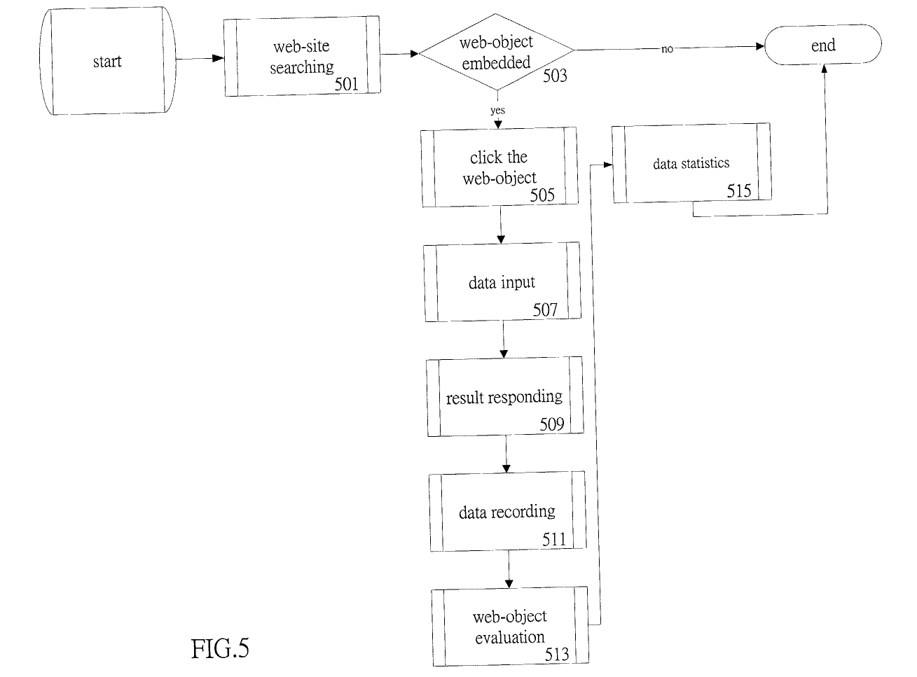

FIG. 5 is a flowchart illustrating the processes for the browsers to search information from the network, comprising the following steps:

Step 501: Web-site Searching. Internet browsers input keywords for searching the web-sites or web-pages. The system send back the searching result to the browsers.

Step 503: Web-object embedded? Check if there is any web-object embedded in the web-site (or web-page) which the browser/user is browsing (e.g., viewing)? If the answer is “YES” then go to Step 505, otherwise go to “END”.

Step 505: Click the web-object. If the browser (or user) “clicks” the web-object, then a serial of procedures predefined by the web-object will be actuated.

Step 507: Data input. The browser is requested to input some information or data for operation of the web-object.

Step 509: Result responding. The web-object proceeds the predefined procedures based on these input data, and then sends back the result to the browser after operation.

Step 511: Data recording. The web-object includes a procedure to keep and store the information and data of the user into the web-object database.

Step 513: Web-object evaluation. The user (browser) is requested to fill in an evaluation memo or opinion book for evaluating and grading the performance of the web-object.

Step 515: Data statistics. The system analyzes the data recorded in Step 511 periodically and sends statistic reports to the web-site creators. Only the data which the users/browsers agreed to be public will be sent to the web-site creators.

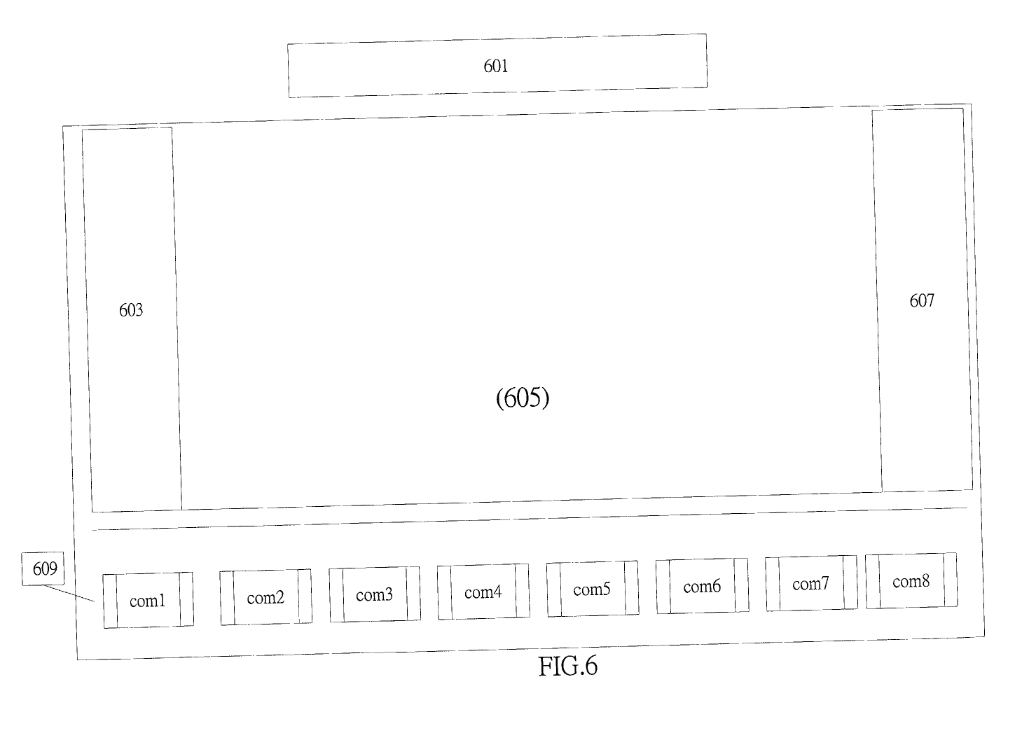

FIG. 6 is a diagram illustrating a preferred homepage showing a search result displayed for the browsers. When a browser enters the keywords for web-site (web-page) searching, the system will perform the searching procedures and send back the searching result to the browser. The search result will be shown on the computer monitor (or computer screen) of the browser. In addition, at least the following frames will be included and shown on the monitor (screen):

Keyword frame 601: This frame is for the browser to key in the keywords.

Search result listing frame 603: The system lists the hyperlinks (URL addresses) of the web-sites search result on the search result listing frame 603 in text format.

Browsers can enter (hyperlink to) one of the web-sites by “clicking” one of the listed hyperlinks.

Web-page presenting frame 605: When the browser “clicks” one of the hyperlinks listed in the search result listing frame 603, the system will display that web-page directly on the web-page presenting frame 605. That means, the browser doesn't need to be completely directed to that web-site which is chosen by “clicking” the hyperlink. The browser is still remaining in the system, and the web-page clicked is only shown on the web-page presenting frame 605 without influencing other frames of the present invention. Therefore, if the browser found that the web-page displayed in the web-page presenting frame 605 is not what he/she wants, then the browser doesn't need to close the current frame nor hyperlink back to the system as which must be done in the prior art. The only thing the browser has to do is to easily choose and click another hyperlink listed in the search result listing frame 603 which is always shown on the screen, and he/she will be able to view another web-page on the web-page presenting frame 605 immediately. Such a design can vastly increase the efficiency and convenience for web-page browsing.

Briefing frame 607: The title and brief description of the web-page are shown in the briefing frame 607. When a browser clicks a hyperlink listed in the search result listing frame 603, the title and brief description of that web-page will also be presented on the brief frame 607 in the same time. The web-site creator is required to key in these title and brief description in text format when he/she registers his/her web-site to the system of the present invention.

Web-object frame 609: If the web-site creator purchases or embeds web-objects in his/her web-page then these web-objects will be shown on the web-object frame 609. The web-objects shown on the web-object frame 609 may various due to different features being provided by different web-pages.

It may thus be seen that the objects of the present invention set forth herein, as well as those made apparent from the foregoing description, are efficiently attained. While the preferred embodiments of the invention have been set forth for purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An executable web-object trading system comprises:
a mainframe for organizing said system, the mainframe being communicating with a network and capable for allowing at least a user to login the mainframe via the network for accessing the system;
a web-object database for storing a plurality of executable web-objects therein, each web-object being capable to proceed a serial of pre-defined processes for performing a pre-determined feature;
a membership database for recording at least a registered data of the user;
a linking module for comparing a login record of the user with the registered data saved in the membership database to check if the user is authorized to select web-objects from the web-object database; and
a web-object embedding module for embedding the web-object selected by the user onto a web-page for providing said feature.

2. The executable web-object trading system of claim 1, further comprising a trading module for the user to select and purchase web-objects.

3. The executable web-object trading system of claim 2, wherein the users of the system includes browsers, web-site creators and web-object creators, said trading module further comprising:
a network service module for proceeding a procedure for the web-site creator to purchase web-objects, a procedure for the web-object creator to register his/her web-object to the system and stored in the web-object database for others to purchase and a procedure for the web-site creator to register his/her web-site to the system for others to browse;
a web-object constructing module for the web-site creator to set up and modify initial settings and parameters of the web-object for future operations, the web-site creator being able to use the web-object constructing module to publish required features and functions of a self-defined web-object on the system such that the web-object creator will be able to produce the self-defined web-object based on the required features and functions; and
a profit sharing module for recording a profit sharing ratio of the self-defined web-object, profit obtained by further trading of the self-defined web-object will be shared by the web-site creator and the web-object creator based on said profit sharing ratio.

4. The executable web-object trading system of claim 3, wherein the membership database further stores expertise and registered information of the web-object creators.

5. The executable web-object trading system of claim 3 further comprising:
a profit sharing database for recording a profit sharing table, said profit sharing table having the following data: basic information of the web-object, information of web-object creator, information of web-site creator, and profit sharing ratio between the system, web-object creator and web-site creator; and
a forum database for storing and recording discussions between web-site creator and web-object creator when they are designing the self-defined web-object.

6. The executable web-object trading system of claim 3, wherein the linking module further comprises:
a virtual web-site linking module for the web-site creator to keep and store web-objects in the mainframe of the system, when a browser clicks the web-object, not only the consequent procedures are performed by the mainframe of the system, but also the records generated by using the web-object are stored and processed by the mainframe of the system; and
an actual web-site linking module for the web-site creator to store the web-objects into his/her web-site, records generated by using the web-object or input by users will not be processed by the mainframe of the system, but will be transmitted directly to the web-site and processed by the web-site creator.

7. The executable web-object trading system of claim 1, wherein the web-object embedding module can embed the web-object into the web-page own by a web-site creator, when a browser clicks to use that web-object, the web-object will record some specific information into the web-object database, compile statistics of these recorded information, and report these statistics to the web-site creator via the network periodically.

8. The executable web-object trading system of claim 1, wherein the system further comprises:
an invoice database for storing billing and accounting records of the system;
an evaluation database for storing evaluation records which are evaluated by users of the web-objects to be a reference record for others to consider if this web-object is worthy to buy, the evaluation database being related to the membership database such that the evaluation records of the web-object can be further relating to expertise of the creator of that web-object.

9. An executable web-object trading method comprises the following steps:
(a) logging in an executable web-object trading system via a network and generating a login record;
(b) comparing the login record with a membership data stored in a membership database of the system;
(c) selecting a web-object from a web-object database of the system;
(d) proceeding a trading procedure when at least one web-object is selected;
(e) embedding the selected web-object into a web-page for providing a pre-determined feature by a web-object embedding module of the system after completing said trading procedure.

10. The executable web-object trading method of claim 9, wherein there are users, browsers, web-site creators and web-object creators who can log in the system, a membership registering procedure will be performed when no membership data can be found to match the login record in step (b).

11. The executable web-object trading method of claim 9 further comprising the following steps:
(d1) setting up initial parameters of the web-object to suit the web-page, the step (d1) is performed between step (d) and step (e);
wherein the step (e) further includes the following steps:
(e1) deciding to save the web-object in either a web-site own by a web-site creator or the system;
(e2) the system transferring the web-object and the initial parameters to the web-site if the web-site creator decides to keep the web-object in that web-site;
(e3) the system requesting the web-site creator to transfer the web-page to the system and stored therein, then embedding the web-object into the web-page.

12. The executable web-object trading method of claim 9 further comprising a web-object constructing procedure which includes the following steps:
(c1) requesting a user to fill in a requirement table for stating required features and specifications of the web-object and due date for completing the web-object;
(c2) publishing the required specifications and features of the web-object on a Bulletin Board of the system to allow a web-object creator to access these information via the network;
(c21) checking the due date, if the due date has expired then delete the published specifications and features from the Bulletin Board;
(c3) performing a meeting by the user and the web-object creator for discussing future selling price, profit sharing ratio and detailed features of the web-object;
(c4) the web-object creator completing the web-object and transferring the web-object to the user via the system.

13. The executable web-object trading method of claim 11, wherein the step (c2) further comprises the following steps:
(c22) searching for and selecting a suitable web-object creator from an evaluation database of the system to make the web-object;
(c23) the system notifying the web-object creator selected by the user, the selected web-object creator may then make contact with the user to discuss about the price and detailed features of the web-object.

14. The executable web-object trading method of claim 9 further comprising a web-object registering procedure for a web-object creator to register his/her web-object in the system for other users to purchase, said web-object registering procedure including the following steps:
(a) inputting basic information and data of the web-object which the web-object creator wants to sell;
(b) the system checking the input information and data;
(c) transferring and storing the web-object and the data thereof into the system;
(d) testing the web-object;
(e) once the web-object passing the test, storing the web-object in the web-object database for other users to select and purchase.

15. The executable web-object trading method of claim 14 further comprising the following steps:
(a1) filling in a profit sharing table for stating profit sharing ratios of the web-object, when this web-object is sold, the profit obtained will be shared by the system, user and web-object creator with the predetermined ratio as which stated in the profit sharing table, this step (a1) being performed after the step (a) of claim 14;
(d1) notifying the web-object creator to correct errors of the web-objects if the web-object did not pass the test mentioned in step (d) of claim 14.

16. The executable web-object trading method of claim 9 further comprising a browsing procedure for a browser to browse and search for web-pages or web-sites in the system, said browsing procedure comprising the following steps:
(a) the browser inputting keywords for searching the web-sites or web-pages, the system sending back searching result to the browser for browsing;
(b) checking if there is any web-object embedded in the web-page which the browser is currently browsing;
(c) the browser clicking the web-object and actuating a serial of procedures predefined by the web-object;
(d) the web-object requesting the browser to input data for operation of the web-object;
(e) the web-object proceeding the predefined procedures based on these input data, and then sending back results to the browser after operation;
(f) the web-object keeping and storing the input data into the web-object database;
(g) the system analyzing the input data periodically and sending statistic reports of the input data to web-site creators.

17. The executable web-object trading method of claim 16, the system sending back the search result of web-pages to the browser, said search result being displayed on a screen of the browser, wherein at least the following frames are displayed on the screen:
a search result listing frame for listing hyperlinks (URL addresses) of the web-sites or web-pages;
a web-page presenting frame for displaying one of the web-pages which is chosen by the browser by “clicking” the hyperlink; and
a web-object frame for showing the embedded web-objects.

18. The executable web-object trading method of claim 17, wherein the frames displayed on the screen further comprises: a briefing frame for displaying title and brief description of the web-page which is shown in the web-page presenting frame.

19. A method for using the executable web-object trading system of claim 1, comprising the following steps:
(a) the user logging in the system via the network and generating the login record;
(b) the linking module comparing the login record with the membership data stored in the membership database of the system;
(c) the user selecting a web-object from the web-object database;
(d) proceeding a trading procedure when at least one web-object is selected by the user;
(e) embedding the selected web-object into the web-page by the web-object embedding module of the system after completing said trading procedure.

20. The method of claim 19, wherein the step (e) further includes the following steps:
(e1) the user deciding to save the web-object in either his/her web-site or the system;
(e2) the system transferring the web-object and the initial parameters to the web-site if the user decides to keep the web-object in that web-site;
(e3) the system requesting the user to transfer the web-page to the system and stored therein, then embedding the web-object into the web-page.

21. The method of claim 19 further comprising a web-object constructing procedure which will be performed if the user cannot find any suitable web-object from the web-object database in step (c), wherein the web-object constructing procedure includes the following steps:
(c1) requesting the user to fill in a requirement table for stating required features and specifications of the web-object and due date for completing the web-object;
(c2) publishing the required specifications and features of the web-object on a Bulletin Board of the system to allow a web-object creator to access these information via the network;
(c21) checking the due date, if the due date has expired then delete the published specifications and features from the Bulletin Board;
(c3) performing a meeting by the user and the web-object creator for discussing future selling price, profit sharing ratio and detailed features of the web-object;
(c4) the web-object creator completing the web-object and transferring the web-object to the user via the system.
